(19) United States
(12) Patent Application Publication
(10) Pub. No.: US 2007/0133768 A1
(43) Pub. Date: Jun. 14, 2007

(54) Fraud detection for use in payment processing

(75) Inventor: Moneet Singh, Conshohocken, PA (US)

Correspondence Address: George J. Awad;Drinker Biddle & Reath LLP, One Logan Square, 18th and Cherry Streets, Philadelphia, PA, 19103-6996, US

(73) Assignee: Sapphire Mobile Systems, Inc.

(21) Appl. No.: 11/638,290

(22) Filed: Dec. 12, 2006

Related U.S. Application Data
(60) Provisional application No. 60/749,458, filed on Dec. 12, 2005.

(51) Int. Cl. H04M 15/00

(52) U.S. Cl. 379/114.14

(57) ABSTRACT

Systems and methods are provided for fraud detection in payment processing. In an illustrative implementation, a fraud detection platform comprises a fraud detection engine and at least one instruction set. In the illustrative implementation, the instruction set comprises one or more instructions to instruct the fraud detection engine to process m-commerce payment transactions according to a selected one or more fraud detection paradigms. In an illustrative operation, the fraud detection engine generates a fraud score that can be calculated by processing payment transactions among a group of users of a payments network based upon the network of other users with whom the user transacts via electronic payments or communications. Further, in the illustrative operation, the fraud scoring processing makes use of a transaction authentication score which can be derived from the strength of the network connection (or, the degree of separation) between two users who are party to the transaction.

### CLAIM OF PRIORITY AND CROSS REFERENCE TO RELATED APPLICATIONS

This non-provisional patent application claims priority to and the benefit of the U.S. provisional patent application 60/749,458, filed on Dec. 12, 2005, entitled, “METHOD AND SYSTEM FOR FRAUD DETECTION IN A PAYMENTS SYSTEM BASED UPON RATINGS SCORE DERIVED FROM THE NETWORK OF CONTACTS AND INTERACTIONS AMONG THE USERS OF THE PAYMENT SYSTEM,” which is herein incorporated by referenced in its entirety.

### BACKGROUND

Although there are various solutions that allow for a mobile phone to be used as a payment device, mobile payments and mobile commerce (“m-commerce”) have not been adopted on a wide scale. Various markets, including the United States, are gearing up for the wide-scale deployment and use of this payment media. Specifically, the financial industry, including banks and issuers of credit cards, are building and deploying infrastructure and services to accommodate for expected growth projections.

Payment transaction processing, like other electronic data processing platforms are prone to significant fraud. Such fraud can wreak havoc on the operators and users of such platforms, often compromising private/confidential information and promoting a lack of confidence by the users whose transaction fees support the platform. Additionally, such fraud is costly as cooperating parties (e.g., banks, card issuers, etc.) are left paying the bill (e.g., through fraud protection insurance policies) when fraudulent transactions occur. Although, there are various fraud detection mechanisms in place, such mechanisms lack reliability and application for m-commerce type payment transactions.

With state of the art fraud detection systems, data points are used to “score” transactions according to the probability that they may be fraudulent. For example, if a user who typically purchases only food with a credit card in $20 amounts suddenly purchases a $5,000 home entertainment system, the fraud detection systems will flag the transaction as potentially fraudulent. Based on other factors, such as the user's payment history or income, the probability score will be higher or lower.

The adoption of the mobile phone as a payments platform will allow telecommunications carriers and financial institutions to expand on anti-fraud and transaction monitoring systems because mobile payment functionality will combine a user's telecommunications behaviors with a user's financial behavior, creating a data set that may be “mined” for typical consumer behavior. In m-commerce, when a mobile phone acts as a payment mechanism, an even greater level of anti-fraud protection may be possible by constructing a fraud detection system and method based on the “network” of contacts that mobile phone users create through their mobile payment transactions with other users and merchants. The network of contacts can also include other users whom the user makes contact with for communications-only messages, such as persons a user frequently calls or communicates with via text messaging.

From the foregoing it is appreciated that there exists a need for systems and methods to ameliorate the shortcomings of existing practices used for fraud detection in payment processing.

### SUMMARY

Systems and methods are provided for fraud detection in payment processing used in m-commerce transactions. In an illustrative implementation, a fraud detection platform comprises a fraud detection engine and at least one instruction set. In the illustrative implementation, the instruction set comprises one or more instructions to instruct the fraud detection engine to process m-commerce payment transactions according to a selected one or more fraud detection paradigms. The selected one or more fraud detection paradigms can include but is not limited to a fraud detection processing using social networking principles.

In an illustrative operation, data is received by the fraud detection engine representative of a user and a payment processing request. Responsive to the payment processing request, the fraud detection engine generates a fraud score which represents a confidence value. In the illustrative operation, the fraud score can be calculated by processing payment transactions among a group of users of a payments network based upon the network of other users with whom the user transacts via electronic payments or communications. Further, in the illustrative operation, the fraud scoring processing makes use of a transaction authentication score which can be derived from the strength of the network connection (or, the degree of separation) between two users who are party to the transaction (e.g., two users engaging in an m-commerce transaction to transfer monies from one user to another).

In the illustrative implementation, the transaction authentication score may be used in conjunction with fraud detection and transaction authorization systems when such systems calculate the probability that monetary transactions are fraudulent.

Other features of the herein described system and methods are further described below.

### BRIEF DESCRIPTION OF THE DRAWINGS

Referring now to the figures, in which like reference numbers refer to like elements throughout the various drawings that comprise the figures. Included in the figures are the following:

FIG. 1 is a block diagram of an exemplary fraud detection environment employing social networking principles in accordance with the in accordance with the herein described systems and methods;

FIG. 2A is a block diagram of exemplary data flow between cooperating components of an exemplary fraud detection environment in accordance with the herein described systems and methods;

FIG. 2B is a block diagram of other exemplary data flow between cooperating components of an exemplary fraud detection environment in accordance with the herein described systems and methods; and

FIG. 3 is a flow diagram of the processing performed when performing fraud detection in accordance with the herein described system and methods.

### DETAILED DESCRIPTION

Overview

The herein described system and methods provide, illustratively, a method for “scoring” payment transactions among a group of users of a payments network based upon the network of other users with whom a user transacts via electronic payments or communications. This scoring makes use of a transaction authentication score which is derived from the “strength” of the network connection (or, the (“degree of separation”) between the two users who are party to the transaction. In an illustrative implementation, the transaction authentication score may be used in conjunction with fraud detection and transaction authorization systems when such systems calculate the probability that monetary transactions are fraudulent.

Illustrative Fraud Detection Environment Using “Social Networking Scoring”

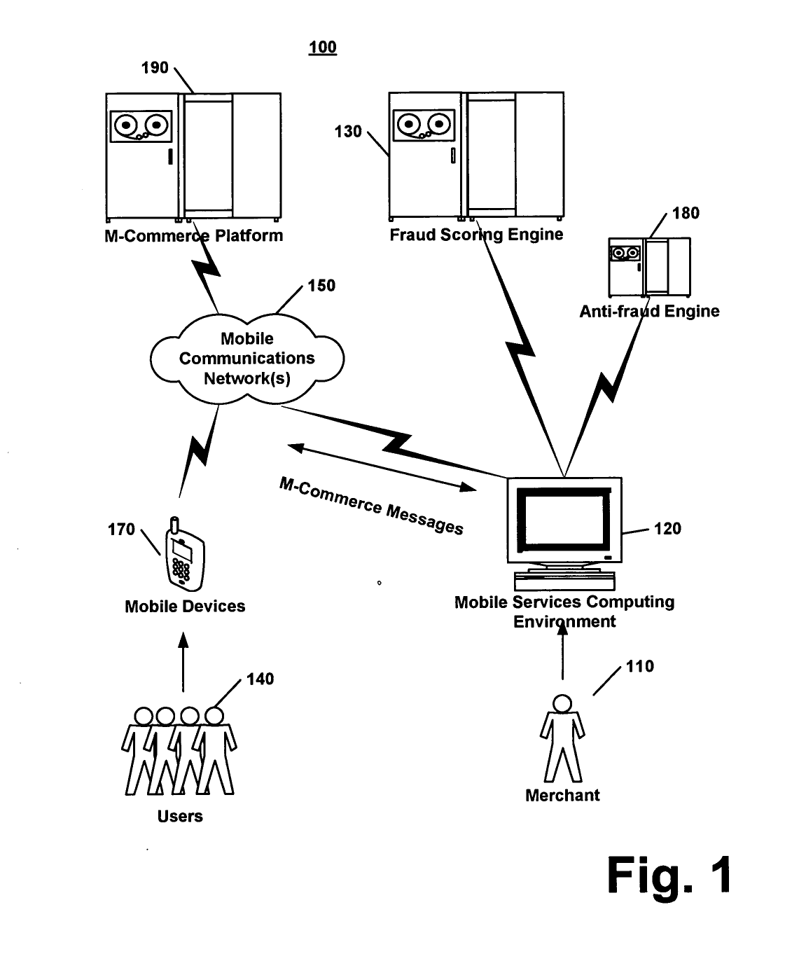

FIG. 1 illustrates the exemplary fraud detection environment 100 (e.g., using social networking principles), which, as shown can comprise merchant 110, mobile services computing environment 120, a fraud scoring engine 130, an anti-fraud engine 180, m-commerce platform 190, users 140 of the merchant's m-commerce service, mobile communications network 150, and mobile communications devices 170, such as mobile devices (e.g., mobile telephones, mobile PDAs, mobile tablets, etc.) with which the users communicate with the merchant computing environment using m-commerce messages, delivered in an illustrative implementation of the herein described systems and methods as SMS messages or MMS messages.

In an illustrative operation, users 140 can engage in an m-commerce transaction with a merchant 110 (or with other users 140 as facilitated by a merchant 110) using mobile communications devices 170 and a merchant computing environment 120 (e.g., mobile services computing environment) operatively coupled using a mobile communications network 150. In the illustrative operation, as part of an m-commerce transaction, a user 140 can, using mobile communications devices 170, enter into a mobile commerce transaction with (or facilitated by) merchant 110 using merchant computing environment 120 and fraud scoring engine 130 (e.g., fraud scoring using social networking principles). The mobile commerce transaction can be further processed and facilitated with the cooperation of m-commerce platform 190. In the illustrative operation, m-commerce platform 190 can provide data and instructions to mobile services computing platform representative of user 140 interactivity on mobile communications network 150.

Upon receiving m-commerce messages from users' 140 mobile communications devices 170, the fraud scoring engine 130 can operate to calculate a transaction authentication score for the various m-commerce transactions in which the users 140 are engaged. Also, in the illustrative operation, merchant computing environment 120 can then use transaction authentication scores in conjunction with the anti-fraud engine 180 (which may consist of “off the shelf” anti-fraud software or hardware) in order to flag certain m-commerce transactions as suspicious and either deny the flagged m-commerce transactions or allow the flagged m-commerce transaction but scrutinize the transaction at a later date to ascertain if it was indeed fraudulent.

It is appreciated that although the exemplary fraud detection environment 100 is described to employ specific components having a particular configuration that such description is merely illustrative as the inventive concepts described herein can be performed by various components in various configurations. For example, although a merchant provider computing environment 120 and fraud detection engine 130 are described to be separate in FIG. 1, such description is merely illustrative as these two computing environments can exist in a single computing environment. Although this disclosure describes the use of the method and system as applied to a mobile payments system, those skilled in the art may apply the method and system to other types of payments systems and networks.

Illustrative Fraud Scoring Process

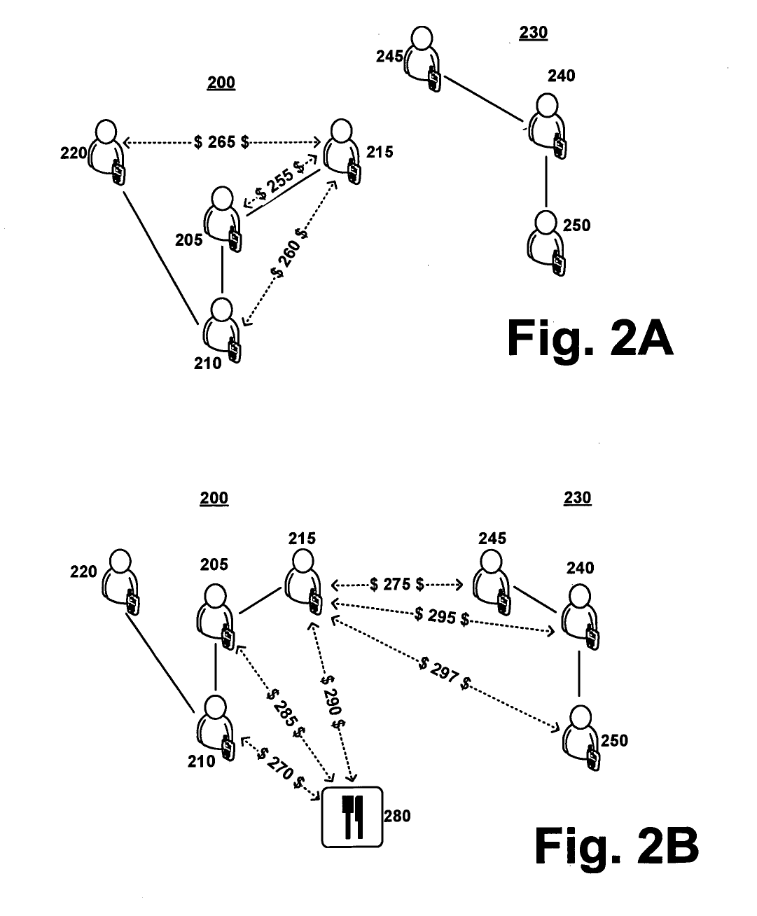

It is appreciated that exemplary fraud detection environment 100 of FIG. 1 can maintain various operations and features. FIGS. 2A and 2B provide an illustrative implementation of exemplary processing performed by exemplary fraud detection environment 100.

FIG. 2A depicts two groups of users 200, 230 of a mobile commerce system. The groups comprises one “node” user 205, 240 and a plurality of users 210, 215, 220, 245, 250 who, illustratively, interact with the “node” users, but under the assumptions of this example, do not yet interact with each other.

As depicted in FIG. 2A, in a group of users 200, a node user 205 may directly interact with users 210, 215, 200 through mobile communications, electronic communications, mobile transactions/payments or electronic transactions/payments as facilitated by their mobile devices. In the illustrative figure, such direct interaction can establish a “one degree of separation” between a node user 205 and other users 210, 215, 200. In an illustrative operation, the herein describes systems and methods can operate to mark any future mobile transaction/payment 255 between a node user 205 and a user 215 as one degree of separation away from the node user and associate a high authentication score because of such relationship (e.g., because of the preexisting level of trust established between the two users due to their regular communications or mobile transactions/payments with each other).

As is shown in FIG. 2A. other users 210 separated by one degree from node users may communicate or engage in mobile transactions/payments with a node user 205 but may not communicate or engage in mobile transactions/payments with other users 215 separated by one degree from the same node users. Such users 210 separated by one degree from node users 205 may be separated by “two degrees of separation” from other such users 215 separated by one degree from node users 205. Although these users separated by two degrees of separation do not communicate with each other, a level of “transitive trust” exists between them due to their communications or mobile transactions/payments with node users 205. This transitive trust can arises in that two persons who have pre-existing relationships with a third person may be more likely to enter into a relationship with each other due to their relationship with the common person. The creation of transitive trust can be used to generate a fraud score that represents a notion that it is more likely that future m-commerce payments/transactions entered into between the two persons are legitimate transactions instead of fraudulent transactions.

Should two users 210, 215 separated by two degrees of separation engage in a mobile transaction/payment 260 (as indicated by the arrows), the herein described systems and methods shall calculate a higher transaction authentication score for such mobile transaction/payment 260 between users 210, 215 bound by this transitive trust than for a mobile transaction/payment between users (e.g., 245 and 215) lacking this transitive trust. The transaction authentication score for transactions 260 between users separated by two degrees of separation 210, 215, however, will be lower than the transaction authentication score for transactions 255 between users separated by one degree of separation 205, 215.

Likewise, a level of transitive trust can exists between two users 215, 220 separated by three degrees of separation. Should two users 215, 220 separated by three degrees of separation engage in a mobile transaction/payment 265, the herein described system and methods shall calculate a higher transaction authentication score for such mobile transaction/payment 265 between users 215, 220 bound by this transitive trust than for a mobile transaction/payment between users lacking this transitive trust. However, in an illustrative operation, such score can be lower for transactions 265 between users separated by three degrees of separation 215, 220 than that for transactions 260 between users separated by two degrees of separation 210, 215 or for transactions 255 between users separated by one degree of separation 205, 215. By mapping out its network of users, an m-commerce platform implementing the herein described system and methods may calculate the “degrees of separation” between any two users entering into an initial m-commerce transaction and calculate the transaction authentication score accordingly.

An m-commerce platform (not shown) implementing the herein described system and methods may apply its calculation of the transaction authentication score to “person to merchant” mobile payments. As is shown in FIG. 2B, user 210 may engage in regular m-commerce transactions/payments 270 with a merchant, such as a restaurant 280 as presented in FIG. 2B, and subsequent transactions between the user 210 and the restaurant 280 will receive high transaction authentication scores since the user and the restaurant have established a “one degree of separation” association.

Additionally, higher transaction authentication scores may be calculated for m-commerce payments/transactions between the restaurant 280 and users 205, 215 who have transitive trust with the restaurant 280 by nature of their relationships (either through their communications histories or m-commerce payment/transaction histories) with a user 210 who had already established a relationship with the restaurant. When users 205, 215 enter into their initial m-commerce payments/transactions 285, 290 with the restaurant 280, these initial transactions 285, 290 will receive higher transaction authentication scores by nature of their existing relationship with a user 210 who is a current or former patron of the restaurant 280. An example of this transitive trust is that a user may be a patron of a restaurant and then tell users with whom he interacts of the quality of the restaurant and suggest that they patronize it. Thus, it may be presumed that a user may indeed be a customer of a restaurant—and that the m-commerce transaction between the user and the restaurant is not fraudulent—by nature of the user's interaction with a user who is already a patron of the restaurant.

Additionally, in an illustrative implementation, links established through communications or payments/transactions between users of disparate networks can also increase the transaction authentication score for subsequent transactions undertaken by users in the networks. As depicted in FIG. 2A, members of the first network 200 are not members of the second network 230, nor do the two networks have any existing relationships through communicative or transactional contacts. As depicted in FIG. 2B, two users 215, 245 from disparate networks 200, 230 may decide to enter into an m-commerce payment/transaction 275, a transaction which will receive a low transaction authentication score since the two users have no prior history of communications or transactions with each other. As the two users 215, 245 from disparate networks 200, 230 establish a relationship through their m-commerce payments/transactions 275, they will establish a connection linking their two disparate networks 200, 230 and any subsequent transactions between users in the two disparate networks 200, 230 will receive a higher transaction authentication score than they would have received had the two users 215, 245 not established the link through their m-commerce payments/transactions 275.

By establishing the link between the two disparate networks 200, 230 through their m-commerce payments/transactions 275, the two users 215, 245 establish a level of transitive trust between the members of the networks. For example, if one of the users 215 of one of the disparate networks 200 enters into an m-commerce payment/transaction 295 with another user 240 of the other disparate network 230, the m-commerce payment/transaction could receive a higher transaction authentication score than it would have received had the initial m-commerce payment/transaction 275 which linked the two disparate networks 200, 230 not been made.

In this example, after the initial m-commerce payment/transaction 275 which linked the two disparate networks 200, 230 has been made, the first user 215 is now separated by two degrees of separation from the other user 240, and their m-commerce payment/transaction 295 will be scored accordingly. Likewise, the first user 215 may enter into an m-commerce payment/transaction 297 with another user 250 of the other network 230 and the m-commerce payment/transaction 297 will be scored as that of an m-commerce payment/transaction in which the users are separated by three degrees of separation. In the example provided, the m-commerce payment/transaction 275 linking the two disparate networks 200, 230 allowed for a higher scoring for transactions 295, 297.

An exemplary m-commerce platform implementing the herein described system and methods can maintain data related to the mobile communications or mobile payments/transactions between its users and can calculate the transaction authentication score based upon the frequency and type of these transactions. For example, two users separated by one degree of separation who engage in regular m-commerce transactions with each other can receive a higher transaction authentication score for their monetary transactions than two users separated by one degree of separation who engage only in periodic m-commerce transactions with each other. Likewise, two users separated by one degree of separation who engage in regular mobile communications with each other can receive a higher transaction authentication score for their monetary transactions than two users separated by one degree of separation who engage only in periodic mobile communications with each other.

The herein described system and methods can also modify the transaction authentication score for m-commerce payments/transactions using various mobile network data including but not limited to the frequency, duration and timing of cellular calls between users; frequency of Short Message Service (SMS or “text message” communications between users; and frequency of messages sent using the Multimedia Messaging Service (MMS) between users. M-commerce transactions between users can also cause subsequent transaction authentication scores for transactions between the users to be higher than transaction authentication scores between similar users who do not engage in m-commerce transactions. The herein described system and methods may also calculate subsequent transaction authentication score values using the monetary value of prior m-commerce transactions.

In an illustrative implementation and as described in FIG. 1, the transaction authentication score can be used with currently available fraud detection and transaction authorization systems that are based on transaction parameters (including but not limited to transaction size, frequency, location, date and time) to calculate a probability that the transaction is fraudulent and trigger scrutiny on a transaction. The transaction authentication score, as described herein, may also be used in conjunction with other rating mechanisms, such as “peer review” scoring.

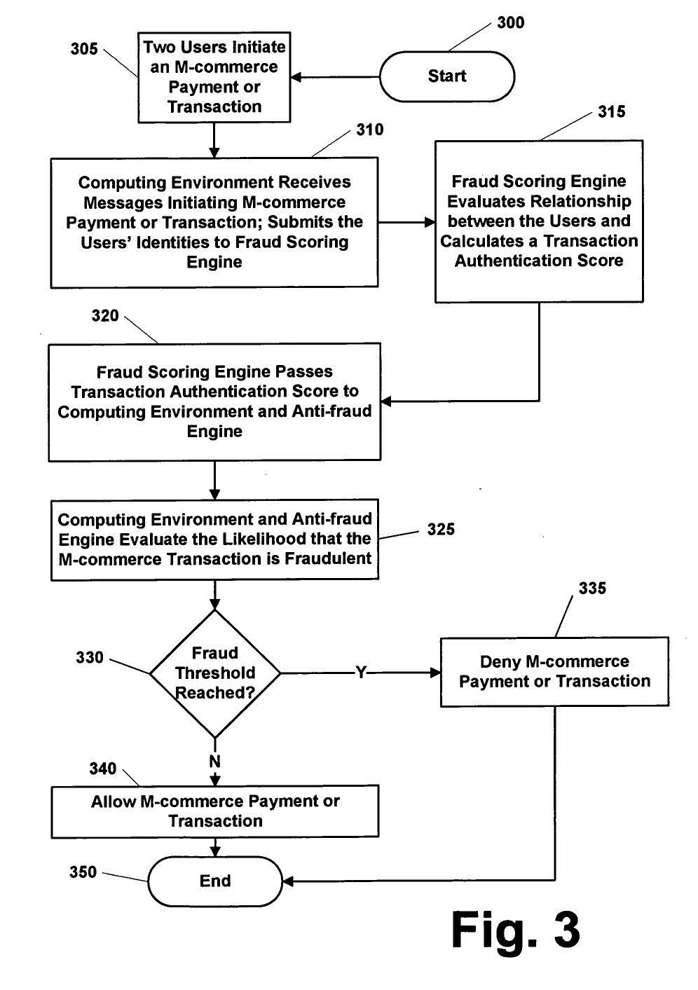

FIG. 3 provides a flow chart that describes the processing performed in fraud detection when applying herein described system and methods in which two parties attempt to engage in an m-commerce payment/transaction using text messages remitted to an m-commerce system which has implemented the invention.

As is shown, processing begins at block 300 and proceeds to block 305 where two users of an m-commerce system decide to enter into an m-commerce payment/transaction. The two users can remit text messages to a cooperating m-commerce platform to begin the transaction at block 305. The text messages are then received by the computing environment managing the m-commerce system at block 310, which passes the identity of the users to the fraud scoring engine. Processing then proceeds to block 315 where the fraud scoring engine evaluates the relationship between the users involved in the m-commerce payment/transaction and calculates a transaction authentication score and passes the calculated transaction authentication score to the computing environment managing the m-commerce platform (190 of FIG. 1) and the anti-fraud engine which interacts with the computing environment at block 320.

The computing environment managing the m-commerce system and the anti-fraud engine can then use the transaction authentication score in conjunction with other anti-fraud mechanisms to determine if the intended m-commerce payment/transaction is fraudulent at block 325. A check is then performed at block 330 to determine if the calculated fraud score (e.g., transaction authorization score) is greater than or equal to a selected fraud threshold. If the check at block 330 indicates that the selected fraud threshold has been reached, the intended m-commerce payment/transaction may be denied at block 335. Processing then terminates at block 340.

However, if the check at block 330 indicates that the calculated fraud score is below the selected fraud threshold, then the m-commerce payment/transaction will be allowed at block 340, after which the process ends 350.

Although described in the setting of a mobile payment or transaction, the herein described system and methods may be applied to any payment or transaction undertaken by electronic means, such as by email messages or other transactions undertaken using the Internet.

It is understood that the herein described systems and methods are susceptible to various modifications and alternative constructions. There is no intention to limit the herein described system and methods to the specific constructions described herein. On the contrary, the invention is intended to cover all modifications, alternative constructions, and equivalents falling within the scope and spirit of the herein described system and methods.

It should also be noted that the herein described system and methods may be implemented in a variety of computer environments (including both non-wireless and wireless computer environments), partial computing environments, and real world environments. The various techniques described herein may be implemented in hardware or software, or a combination of both. Preferably, the techniques are implemented in computing environments maintaining programmable computers that include a processor, a storage medium readable by the processor (including volatile and non-volatile memory and/or storage elements), at least one input device, and at least one output device. Computing hardware logic cooperating with various instruction sets are applied to data to perform the functions described above and to generate output information. The output information is applied to one or more output devices. Programs used by the exemplary computing hardware may be preferably implemented in various programming languages, including high level procedural or object oriented programming language to communicate with a computer system. Illustratively the herein described apparatus and methods may be implemented in assembly or machine language, if desired. In any case, the language may be a compiled or interpreted language. Each such computer program is preferably stored on a storage medium or device (e.g., ROM or magnetic disk) that is readable by a general or special purpose programmable computer for configuring and operating the computer when the storage medium or device is read by the computer to perform the procedures described above. The apparatus may also be considered to be implemented as a computer-readable storage medium, configured with a computer program, where the storage medium so configured causes a computer to operate in a specific and predefined manner.

Although an exemplary implementation of the herein described system and methods has been described in detail above, those skilled in the art will readily appreciate that many additional modifications are possible in the exemplary embodiments without materially departing from the novel teachings and advantages of the invention. Accordingly, these and all such modifications are intended to be included within the scope of the herein described system and methods. The herein described system and methods may be better defined by the following exemplary claims.

What is claimed is:

1. A system for fraud detection comprising:
a fraud scoring engine; and
an instruction set having at least one instruction to instruct the fraud scoring engine to generate a fraud score for use in fraud detection processing,
wherein the fraud score is calculated using data representative of users interaction with each other over a mobile communications platform comprising mobile telephony, text messaging, short message service, and m-commerce transactions,
wherein the data representative of users interaction comprises data representative of the degree of relationship between a user and other users.

2. The system as recited in claim 1 further comprising a communications network operable to communicate data to and from the fraud scoring engine.

3. The system as recited in claim 2 further comprising a mobile device cooperating with the fraud scoring engine using the communications network.

4. The system as recited in claim 3 further comprising a mobile commerce (m-commerce) platform cooperating with the fraud scoring engine to provide data representative of user interactivity over communications network.

5. The system as recited in claim 1 wherein the fraud scoring engine comprises a computing environment.

6. The system as recited in claim 5 wherein the fraud scoring engine comprises a computing application operating on a computing environment that cooperates with a mobile service computing environment to generate fraud detection data.

7. The system as recited in claim 1 further comprising an anti-fraud engine cooperating with the fraud scoring engine to receive data representative of fraud scores generated by the fraud scoring engine as part a selected fraud detection processing scheme.

8. The system as recited in claim 7 wherein the fraud scores comprise transaction authorization scores.

9. The system as recited in claim 1 further comprising mobile devices operable to cooperated with a cooperating mobile communications network which is operatively coupled to the fraud scoring engine.

10. The system as recited in claim 9 wherein the mobile devices provide data representative of user interactivity over a cooperating mobile communications network to the fraud scoring engine.

11. A method to detect fraud comprising:
receiving data representative of a user's interactivity with other users of a mobile communications network;
mapping a degree separation tree between users of the mobile communications network using the received user interactivity data to generate degree separation data; and
processing the interactivity data and the degree separation data to generate a fraud score.

12. The method as recited in claim 11 further comprising communicating the generated fraud score to cooperating an anti-fraud engine for use by the anti-fraud engine as part of fraud detection processing.

13. The method as recited in claim 11 further comprising selecting a threshold fraud value representative of a high confidence of fraud.

14. The method as recited in claim 13 further comprising comparing the generated fraud score with the threshold fraud value to determine if a transaction engaged in over the mobile communications network is fraudulent.

15. The method as recited in claim 11 further comprising generating a high fraud score representative of a low risk of fraud for various interactivity data comprising: low order degree of separations, frequency of interactivity over the mobile communications network as between two parties of a transaction, time and date of a transaction, and size of a transaction.

16. The method as recited in claim 11 further comprising generating a fraud score for users across more than one mobile communications network.

17. The method as recited in claim 16 further comprising generating the fraud score relying on transitive trust between users of disparate mobile communications networks.

18. The method as recited in claim 11 further comprising receiving from a cooperating m-commerce platform data representative of a user's interactivity with other users of a mobile communications network

19. The method as recited in claim 11 further comprising receiving from one or more mobile devices data representative of a user's interactivity with other users of a mobile communications network

20. A computer readable medium having computer readable instructions to instruct a computer to perform a method comprising:
receiving data representative of a user's interactivity with other users of a mobile communications network;
mapping a degree separation tree between users of the mobile communications network using the received user interactivity data to generate degree separation data; and
processing the interactivity data and the degree separation data to generate a fraud score.
